(19) United States
(12) Patent Application Publication
(10) Pub. No.: US 2024/0399637 A1
(43) Pub. Date: Dec. 5, 2024

(54) ARTICLES OF MANUFACTURE PRODUCED FROM ACRYLIC/ABS LAMINATED SHEET

(71) Applicant: Trinseo Europe GmbH, Horgen (CH)

(72) Inventors: Ronald Lun, Florence, KY (US); Mark Gatman, Erlanger, KY (US); Sebastian Joseph, Mason, OH (US)

(21) Appl. No.: 18/691,206

(22) PCT Filed: Sep. 14, 2022
(86) PCT No.: PCT/US2022/076419

§ 371 Date: Mar. 12, 2024

Related U.S. Application Data
(60) Provisional application No. 63/243,975, filed on Sep. 14, 2021.

(51) Int. Cl. B29C 48/00; B29C 48/08; B29C 51/14; B29K 33/00; B29L 31/30; B32B 27/08; B32B 27/20; B32B 27/30; B62D 35/00

(52) U.S. Cl. CPC B29C 48/0021; B29C 48/022; B29C 48/08; B32B 27/08; B32B 27/20; B32B 27/302; B32B 27/308; B29C 51/14; B29K 2033/12; B29L 2031/3005; B32B 2250/246; B32B 2264/104; B32B 2605/00; B62D 35/00

(57) ABSTRACT

A method is described for making a thermoformable laminate article. The method includes passing a lightly cross-linked acrylic sheet having a thickness about 0.1 inch to about 0.250 inch into a roll stack, co-feeding into the roll stack an ABS web about 0.1 to about 0.4 inch thick heated to about 450° F. to about 550° F. and cooling and compressing the co-fed sheets between rolls under compression.

### RELATED APPLICATION

This application claims priority to U.S. Provisional Application No. 63/243,975, filed Sep. 14, 2021, the subject matter of which is incorporated herein by reference in its entirety.

### BACKGROUND

Fiberglass gel coat materials have become the industry standard for certain transportation applications including the end caps and sidewalls for recreational vehicles, wind deflectors and panels for semi-trucks and the like. While having a low coefficient of thermal expansion, get coat materials lack sufficient weatherability and impact performance. That is, gel coat products tend to yellow with (even short term) environmental exposure and gel coat products tend to chip when road debris such as gravel impinge the surface. Chips remove the gel coat and undesirable expose the underlying fiberglass material. Chips are generally repaired by laboursome filling, sanding and painting. Thus, there is need for a material and products composed thereof with a low coefficient of thermal expansion, good weatherability, and high impact performance for transportation applications like the RV end cap.

The manufacture of crossslinked acrylic sheet to ABS has been described in U.S. Pat. No. 5,069,851, specifically, the manufacture of laminated acrylonitrile-butadiene-styrene (ABS) and cross-linked polymethylmethacrylate (“XPMMA” or “Acrylic”). The laminated product made in the disclosed process of U.S. Pat. No. 5,069,851 exhibits excellent impact resistance properties as compared to polymethylmethacrylate (PMMA) alone, or XPMMA, while preserving the excellent appearance and thermoforming properties of PMMA as well as exhibiting excellent bonding of the two layers.

### SUMMARY OF THE DISCLOSURE

The present disclosure is directed to improvements in the formulation of laminated acrylic sheet to ABS (Acrylic/ABS) and articles composed thereof for transportation applications, where the coefficient of thermal expansion needs to be low to compensate for the thermal expansion and contraction due to swings in the ambient temperature, and excellent impact resistance for debris is desired. However, it is to be appreciated that the present exemplary embodiments are also amenable to other like applications.

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Disclosed herein are Acrylic/ABS laminate materials and products thereof that meet the high demands of the transportation industry, including weatherability, impact resistance, and low thermal expansion. The Acrylic may include a filler e.g., calcium carbonate, of up to 10%. The introduction of the relatively small amount of filler enhances the thermal expansion properties of the material/product, while having only a minimal effect on the loss of gloss experienced from thermoforming processes.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a perspective view of a recreational vehicle with an end cap in accordance with the present disclosure.

FIG. 2 is a block diagram of a method for producing a 3-dimensional transportation article, e.g., an RV end cap, in accordance with the present disclosure.

### DETAILED DESCRIPTION

A more complete understanding of the materials, articles, components, processes and apparatuses disclosed herein can be obtained by reference to the accompanying drawings. These figures are merely schematic representations based on convenience and the ease of demonstrating the present disclosure and are therefore not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The present disclosure relates to exterior vehicle components and panels composed of a formable acrylonitrile-butadiene-styrene (ABS) and cross-linked polymethylmethacrylate (“XPMMA” or “Acrylic”) laminate. The dual layer laminated product is thermoformable to complex shapes. Sheet and thermoformed products exhibit excellent impact resistance properties and weatherability while substantially preserving the desirable gloss-like aesthetic of the material. Generally, fillers are not used in the acrylic sheet used in the lamination to ABS in part due to the effect of the filler on increasing the loss in gloss during thermoforming. However, the Applicant has found that the use of a mineral filler has a reducing effect on the coefficient of thermal expansion of the material which is highly desirable in the transportation industry. Furthermore, at a small composition by weight the filler had only a minimal effect on the loss of gloss when thermoforming the shallow depths of certain components, e.g., the end cap of a Recreational Vehicle. Specifically, the use of a filler such as calcium carbonate up to loadings of 10% resulted in a gloss reduction of only about 10 Gloss units when formed to shallow depths such as those encountered in the thermoforming of an RV end cap.

Thermoformable sheets of ABS and PMMA may be made by continuously manufacturing a dual-layer thermoformable sheet of ABS and PMMA. Generally, the process includes (a) passing an acrylic sheet of the type defined further herein optionally through a heating zone where it is heated to a temperature up to about 350° F. (b) feeding the acrylic sheet into a roll stack; (c) co-feeding into the roll stack an ABS melt sheet, or web, from an extruder; (d) cooling and compressing the co-fed sheets between rolls under compression; and, (e) cooling said sheet.

As used herein a “continuous” process is a process involving an acrylic sheet longer than ten feet or so. The lamination process generally involves the use of acrylic sheet which is in the form of large rolls of 400 to 600 feet even though the sheet may be as thick as 0.250″. The process may also employ acrylic sheet about 0.06″ to about 0.250″ thick and about 36″ to about 110″ wide, in lengths of at least 400 feet. Such lengths may be made in the manner described in U.S. Pat. Nos. 3,371,383 and 3,376,371 to Hellsund and Opel et al, respectively. The acrylic sheet may be taken off the casting and placed in large rolls for use in the lamination process. More particularly, the acrylic sheet may be made of cross-linked polymethylmethacrylate, having about 0.1% to about 0.3% of a cross-linking monomer selected from ethylene glycol dimethacrylate, polyethylene dimethacrylate, butane, hexane and/or higher dimethacrylate, e.g., any dimethacrylate having a linking group of up to about ten carbon atoms, and in which about 10 to about 20% of the polymethylmethacrylate is not cross-linked.

The acrylic is in the form of sheet and made by polymerizing a mixture of monomers comprising methylmethacrylate with up to about 8% by weight other acrylate esters (such as butyl acrylate) and about 0.1% by weight to about 0.3% by weight cross-linking monomer which may include discrete particles of “impact modifier” as is known in the art; however, such impact modifiers are not necessary. The acrylic sheet is about 0.06 to about 0.25 inch, conveniently, from about 0.08 inch to about 0.187 inch thick, most preferably about 0.100 to about 0.150 inch.

The predominantly cross-linked PMMA described above is tough and provides a swell index of about 10 to about 15. The uncross-linked portion, comprising about 10% to about 20% of the sheet, helps to facilitate the penetration of the acrylic sheet by the styrene-acrylonitrile (SAN) of the ABS, since the SAN and the uncrosslinked PMMA are miscible.

The ABS may be any of the acrylonitrile-butadiene-styrene materials commonly found in commerce, used in a form that is conveniently extruded to the same width as the width of the acrylic. Acrylonitrile-butadiene-styrene (ABS) polymers are suitable for use as the substrates of the lamination. ABS resins are polymeric materials made from acrylonitrile, butadiene, and styrene. Some ABS resins are made by polymerizing all three ingredients together. Others are made by block polymerization involving different ones or different mixtures of the three materials in different stages. Still others are made by polymerizing different pairs of these three materials and then blending the copolymers to produce a resin blend containing all three materials. ABS materials suitable for lamination to acrylic as substrates contain from about 15% to about 35% acrylonitrile, from about 10% to about 35% butadiene, and from about 45% to about 65% styrene. Preferably, said materials contain from about 18% to about 24% acrylonitrile, from about 27% to 33% butadiene, and from about 46% to about 52% styrene.

The resulting laminated sheet is generally designed so the acrylic is visible and on the normally used surface (as in a molded shower-tub enclosure, for example), and the ABS provides reinforcement and back-up. The cross-linked acrylic, typically made by casting on machines described in the aforementioned Hellsund and Opel patents generally has a “fine china” sheen, and is harder and more stain and chemical resistant than extruded acrylic sheet.

The interfacial layer between the Acrylic and ABS sheet may be as thick as 50 nanometers, depending on the amount of cross-linking and the time and temperature of conditions within our process, based on an equation for average interpenetration depth given in Zhang and Wool, Macromolecules, Vol. 22 (No. 7), 1989, p. 3020, and assuming a diffusion coefficient for the polymer of 1× 10⁻¹² cm²/sec. Total compression time is about 2.5 minutes, the turning of the rolls providing a laminate velocity of about 18 inches per minute. Throughout the applied range of temperatures the effect of compression pressure and duration of compression can be seen. The strength of the bond is a function of the 0.25 power of contact time. If the desired combined thickness is, for example 0.35 inch, the first roll space should be about 0.340 inch.

Typically fillers are not used in acrylic sheeting to due to loss in impact properties and a decrease in gloss. However, in the present case the addition of fillers may provide desirable properties to the material. In accordance with the present disclosure, in some embodiments, the Acrylic sheet is formulated with a filler component with loadings up to about 10 wt. %. In some embodiments, the filler included in the PMMA sheet is about 7% by weight. It yet still other embodiments, the filler included in the PMMA sheet is about 5% by weight. It yet still other embodiments, the filler included in the PMMA sheet is less than 5% by weight. The filler may have an average particle size (d50) in a range of about 0.1 μm to about 50 μm.

The addition of a filler to the Acrylic formulation results in a lower coefficient of thermal expansion for the final laminated sheet product. In some embodiments, the filler is calcium carbonate. In other embodiments, talc, Alumina trihydrate, wollastonite can also be used. In other embodiments the filler may be a combination of materials.

Exemplary formulation guidelines for the production of the Acrylic Sheet herein are provided in Table 1.

TABLE 1

| Class | Compound | Amount | |
|---|---|---|---|
| Pre-Polymer | Acrylic pre-polymerized syrup | 35-95 | wt % |
| | at 20% solid | | |
| Copolymer or | MMA - methyl methacrylate | 0-10 | wt % |
| comonomer | | | |
| Wetting/dispersing | BYK1142 | 0.0-1 | wt % |
| agent | | | |
| Filler | Calcium Carbonate | 5-20 | wt % |
| Coupling agent | 3-methacryloxypropyl trimethoxy | 0.0-1.0 | wt % |
| | silane | | |
| Anti-flocculating | Triisooctyl phosphate | 0.1-0.8 | wt % |
| agent | | | |
| Pigment | — | 0.5-4.0 | wt % |
| Chain transfer agent | N-dodecyl mercaptan | 0.2-2.0 | wt % |
| Release agent | Zelec UN-Phosphate ester | 0.05-0.1 | wt % |
| Crosslinking agent | Ethylene glycol dimethacrylate | 0.1-1.0 | wt % |
| Initiator 1* | t-butyl peroxypivalate | 0.01-0.4 | wt % |
| Initiator 2* | t-butyl peroxyneodecanoate | 0.0-0.4 | wt % |
| Initiator 3* | t-amyl peroxy-2-ethyl-hexanoate | 0.01-0.2 | wt % |
| Suspension Agent | Silica (fumed and/or precipitated) | 0.1-5.0 | wt % |
| Air Release Agent | BYK 555 | 0.0-1.0 | wt % |

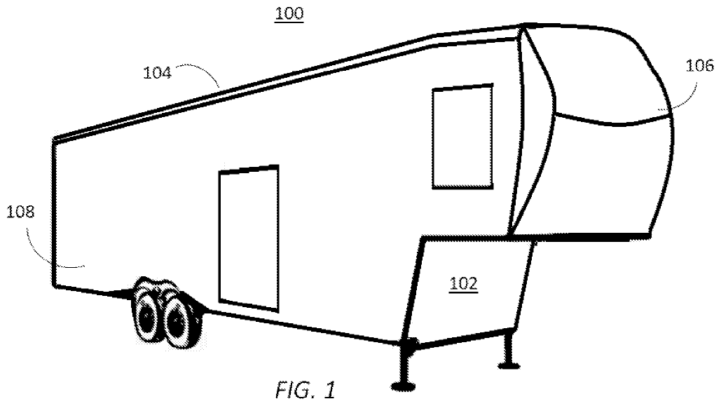

FIG. 1 illustrates an exemplary recreational vehicle in accordance with the present disclosure. The exemplary recreational vehicle 100 of FIG. 1 includes a vehicle body 102 having a plurality of exterior walls, e.g., a roof 104, a front end cap 106, side walls 108, and a rear wall (occluded) mounted to an underframe (not shown) for supporting the vehicle body 102.

The front end cap 106 may be of a 3-dimensional shape for aerodynamic purposes for deflecting air and reducing the wind resistance of the vehicle. In the exemplary embodiment of FIG. 1, the shape of the front end cap 106 is substantially convex although it is to be appreciated that the particular three-dimensional shape is non-limiting.

The 3-dimensional shape of the front end cap 106 is achieved by thermoforming a laminated sheet of acrylic/ABS. In some embodiments, a substantially flat sheet of thermoformable laminated acrylic/ABS (typically about 4.0 mm to about 12.0 mm in thickness) is held by its edges, raised to a thermoforming temperature, and then stretched in relation to a front end cap shaped mold. Typically, the convex portion of the end cap 106 experiences more stretching than the perimeter as the sheet material is typical held approximate the edges. Due to the lower amount of stretch for the RV end cap 106, the finished product generally exhibits a substantially uniform aesthetic.

The gloss of a material is generally measured by a glossmeter (generally at 60 degrees). The gloss of a sheet of laminated Acrylic/ABS may have a gloss greater than about 70 units. In some embodiments, the gloss of a sheet of laminated Acrylic/ABS may have a gloss of about 95 units. During forming of low curvature products, loss in gloss is may be minimized despite the presence of a filler material. For example and without limitation, a thermoformed laminated Acrylic/ABS sheet having less than 10% wt. filler may have a final gloss of about 70 units for front end cap 106 applications.

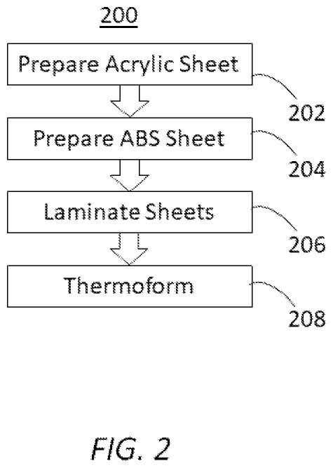

FIG. 2 is a block diagram of an exemplary method for manufacturing a thermoformed component of a vehicle, including but not limited to an RV end cap 106. The method 200 includes, at block 202 preparing an acrylic sheet as described above and configured for lamination to an ABS sheet. That is, an acrylic formulation is made and cast into an acrylic sheet/roll. In some embodiments, preparing a laminated Acrylic/ABS sheet includes the addition of a filler up to 10% wt. in the acrylic formulation. In some embodiments, the filler is calcium carbonate.

At block 204, the method includes preparing an ABS sheet as described above and configured for lamination to an Acrylic sheet. Blocks 202 and 204 may be performed in any order and/or simultaneously.

At block 206, each sheet (ABS and Acrylic) are combined as described above and in U.S. Pat. No. 5,069,851 to create a laminated Acrylic/ABS sheet.

At block 208, the sheet of laminated Acrylic/ABS is thermoformed to a final article shape. That is, the sheet of laminated Acrylic/ABS is heated to a pliable thermoforming temperature and formed to a specific shape in a mold. In some embodiments, the thermoforming temperature is the glass transition temperature of the laminated Acrylic/ABS. In other embodiments, the thermoforming temperature is a temperature greater than the glass transition temperature of the laminated Acrylic/ABS. In some embodiments, the Thermoforming temperature is in the range 360 to 380° F.

It is to be appreciated that various different conventional thermoforming process may be used to create thermoformed articles having a pleasing finish, enhanced weatherability and impact resistance. In some embodiments, the thermoforming process is vacuum forming. In other embodiments, the thermoforming process is pressure forming. In yet still other embodiments, the thermoforming process is a combination of vacuum and pressure forming.

Advantages of the thermoformed articles composed of laminated Acrylic/ABS include weather ability and impact resistance compared to fiberglass gel coated materials. The addition of the calcium carbonate filler provides for a coefficient of thermal expansion that approaches that of fiberglass as compared to standard acrylic.

Other advantages relate to repair of the laminated Acrylic/ABS article. That is, repair of the disclosed articles is fairly easy. Areas the end that become scuffed or scratched (e.g. from road hazards/gravel/and the like) may repaired by mechanically treating the scuffed/scratched surface, e.g., with sand paper. Since the material composition is substantially uniform throughout a certain thickness of the article the repaired area may blend in with the remaining matte surface of the article.

### Additional Embodiments

The present disclosure is also directed to the following exemplary embodiments:
Embodiment 1: A method comprising passing a lightly cross-linked acrylic sheet having a thickness about 0.1 inch to about 0.250 inch into a roll stack; co-feeding into the roll stack an ABS web about 0.1 to about 0.4 inch thick heated to about 450° F. to about 550° F., wherein the acrylonitrile content of the styrene-acrylonitrile component is about 10% to about 33% by weight, from an extruder to achieve intimate contact between the ABS and the acrylic sheet; and cooling and compressing the co-fed sheets between rolls under compression.
Embodiment 2: The method of embodiment 1, wherein the acrylic sheet comprises less than about 10% wt. filler.
Embodiment 3: The method of embodiment 2, wherein the filler is calcium carbonate.
Embodiment 4: The method of any of the embodiments 1-3, wherein the acrylic sheet comprises about 7% wt. filler.
Embodiment 5: The method of any of the embodiments 1-3, wherein the acrylic sheet comprises about 5% wt. filler.
Embodiment 6: The method of any of the embodiments 1-5, wherein the laminate article is an end cap for a recreational vehicle.
Embodiment 7: The method of any of the embodiments 1-6, further comprising thermoforming the laminated sheets to a mold.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related, and other constraints, which vary by implementation and from time to time. While a developer's efforts might be time-consuming, such efforts would be, nevertheless, a routine undertaking for those of ordinary skill in the art and having benefit of this disclosure.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed, including the lower limit and upper limit. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

The invention claimed is:

1. A method of making a thermoformable laminate article, comprising:
passing a lightly cross-linked acrylic sheet having a thickness about 0.1 inch to about 0.250 inch into a roll stack;
co-feeding into the roll stack an ABS web about 0.1 to about 0.4 inch thick heated to about 450° F. to about 550° F., wherein the acrylonitrile content of the styrene-acrylonitrile component is about 10% to about 33% by weight, from an extruder to achieve intimate contact between the ABS and the acrylic sheet; and
cooling and compressing the co-fed sheets between rolls under compression.

2. The method of claim 1, wherein the acrylic sheet comprises less than about 10% wt. filler.

3. The method of claim 2, wherein the filler is calcium carbonate.

4. The method of claim 1, wherein the acrylic sheet comprises about 7% wt. filler.

5. The method of claim 1, wherein the acrylic sheet comprises about 5% wt. filler.

6. The method of claim 1, wherein the laminate article is an end cap for a recreational vehicle.

7. The method of claim 1, further comprising thermoforming the laminated sheets to a mold.

8. A thermoformed laminate article, comprising:
an acrylic top sheet and an ABS bottom sheet.
